(19) United States
(12) Patent Application Publication
(10) Pub. No.: US 2008/0288672 A1
(43) Pub. Date: Nov. 20, 2008

(54) INFORMATION PROCESSING SYSTEM, INFORMATION TERMINAL AND SERVER APPARATUS

(75) Inventor: Kazuyuki SHIBUYA, Sagamihara-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OLYMPUS CORPORATION, Tokyo (JP)

(21) Appl. No.: 12/121,181

(22) Filed: May 15, 2008

(30) Foreign Application Priority Data
May 15, 2007 (JP) 2007-129681

(51) Int. Cl. G06F 15/16; G06F 3/00

(52) U.S. Cl. 710/48; 709/203; 710/52

(57) ABSTRACT

An information processing system includes an information terminal, and a server apparatus connected with the information terminal in a data communicable manner. The server apparatus includes a screen data generation unit configured to generate screen data of a screen to be displayed on an operation screen of the information terminal in response to one of data transmitted from the information terminal and internal processing of the server apparatus and to transmit the screen data to the information terminal. The information terminal includes an operation input unit configured to perform an operation input regarding the information terminal, an operation screen control unit configured to update display content on the operation screen of the information terminal on the basis of the screen data to be transmitted from the server apparatus, and a storage unit configured to store the display content displayed on the operation screen in response to a first operation input.

### CROSS-REFERENCE TO RELATED APPLICATIONS

This application is based upon and claims the benefit of priority from prior Japanese Patent Application No. 2007-129681, filed May 15, 2007, the entire contents of which are incorporated herein by reference.

### BACKGROUND OF THE INVENTION

1. Field of the Invention

The present invention relates to an information processing system configured to store display content to be displayed on an operation screen of an information terminal in response to data transmitted from the information terminal or processing in a server apparatus, and the information terminal and the server apparatus for use in the information processing system.

2. Description of the Related Art

Conventionally, a remote control system has been used. The remote control system controls an application program to be operated in the server apparatus by using an input interface on a side of a client terminal that is the information terminal. The remote control system displays an operation result of the application program in the server apparatus or a display screen of the server apparatus on a display device on the side of the information terminal.

The information processing system performing such remote control is used to be configured in an environment for research and development by using a work station, a super computer, etc. Meanwhile, recently, a processing ability of a CPU and a network environment have been improved, and with the evolution of an OS, the information processing system has been provided with a remote control protocol such as Remote Desktop Protocol (RDP). Thereby, as regards the information terminal, of course in a personal computer (PC), even in a consumer environment using a mobile terminal such as a cellular phone, a PDA and a digital still camera have become possible to utilize the information processing system using such remote control.

A technique, which transmits display images on other display devices to the mobile terminal from the other display devices in accordance with an instruction from the mobile terminal to record the display image in the mobile terminal, has been disclosed in Jpn. Pat. Appln. KOKAI Publication No. 2002-165177.

### BRIEF SUMMARY OF THE INVENTION

According to a first aspect of the present invention, there is provided an information processing system, comprising:

an information terminal; and

a server apparatus connected with the information terminal in a data communicable manner,

the server apparatus including a screen data generation unit configured to generate screen data of a screen to be displayed on an operation screen of the information terminal in response to one of data transmitted from the information terminal and internal processing of the server apparatus and to transmit the screen data to the information terminal, and

the information terminal including:

an operation input unit configured to perform an operation input regarding the information terminal;

an operation screen control unit configured to update display content on the operation screen of the information terminal on the basis of the screen data to be transmitted from the server apparatus; and

a storage unit configured to store the display content displayed on the operation screen in response to a first operation input.

According to a second aspect of the present invention, there is provided an information processing system, comprising:

an information terminal; and

a server apparatus connected with the information terminal in a data communicable manner,

the server apparatus including a screen data generation unit configured to generate screen data of a screen to be displayed on an operation screen of the information terminal in response to one of data transmitted from the information terminal and internal processing of the server apparatus and to transmit the screen data to the information terminal, and

the information terminal including:

an operation input unit configured to perform an operation input regarding the information terminal;

an operation screen control unit configured to update display content on the operation screen of the information terminal on the basis of the screen data to be transmitted from the server apparatus; and

a storage unit configured to start to store the display content displayed on the operation screen in response to a third operation input, and to terminate to store the display content displayed on the operation screen in response to a fourth operation input.

According to a third aspect of the present invention, there is provided an information terminal which is data communicable with an external server apparatus, comprising:

an operation screen control unit configured to update display content of an operation screen on the basis of screen data to be transmitted from the server apparatus;

an operation input unit configured to perform an operation input regarding the information terminal; and

a storage unit configured to store the display content displayed on the operation screen in response to a first operation input.

According to a fourth aspect of the present invention, there is provided a server device connected with an external information terminal in a data communicable manner, comprising:

a screen data generation unit configured to generate screen data of a screen to be displayed on an operation screen of the external information terminal in response to one of data transmitted from the external information terminal and processing in the server apparatus and to transmit the screen data to the external information terminal; and

a screen data transmission control unit configured to stop to transmit the screen data to the external information terminal when a transmission stop request of the screen data is made from the external information terminal, and to restart to transmit the screen data to the external information terminal when a transmission restart request of the screen data is made from the external information terminal.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view depicting a configuration of an information processing system regarding a first embodiment of the invention;

FIG. 2 is a view depicting operations of a server and a digital still camera in response to an operation of the digital still camera;

FIG. 3 is a view depicting an operation result when a user inputs a “decision” by an input interface unit on the basis of an image on a server screen displayed on a display unit of the digital still camera;

FIG. 4A is a view depicting a first half of a flowchart of a series of operations of a remote control program to be executed by a CPU of the digital still camera in the information processing system regarding the first embodiment;

FIG. 4B is a view depicting a second half of the flowchart of the series of the operations of the remote control program to be executed by the CPU of the digital still camera in the information processing system regarding the first embodiment;

FIG. 5 is a view for explaining the operations of the server and the digital still camera in the information processing system regarding the first embodiment;

FIG. 6A is a view depicting a first half of a flowchart of a series of operations of a remote control program to be executed by a CPU of a digital still camera in an information processing system regarding a second embodiment;

FIG. 6B is a view depicting a second half of the flowchart of the series of the operations of the remote control program to be executed by the CPU of the digital still camera in the information processing system regarding the second embodiment;

FIG. 7A is a view depicting a first half of a flowchart of a series of operations of a remote control program to be executed by a CPU of a server in the information processing system regarding the second embodiment;

FIG. 7B is a view depicting a second half of the flowchart of the series of the operations of the remote control program to be executed by the server in the information processing system regarding the second embodiment;

FIG. 8 is a view for explaining operations of the server and the digital still camera in the information processing system regarding the second embodiment;

FIG. 9A is a view depicting a first half of a flowchart of a series of operations of a remote control program to be executed by a CPU of a digital still camera in an information processing system regarding a third embodiment;

FIG. 9B is a view depicting a second half of the flowchart of the series of the operations of the remote control program to be executed by the CPU of the digital still camera in the information processing system regarding the third embodiment;

FIG. 10 is a view for explaining operations of a server and the digital still camera in the information processing system regarding the third embodiment; and

FIG. 11 is a view depicting a flowchart corresponding to FIG. 9B for explaining a modified example of the third embodiment.

### DETAILED DESCRIPTION OF THE INVENTION

Hereinafter, the best form for executing the invention will be described with reference to the drawings.

In the following description, while the form will be described by mainly using a digital still camera as an example of an information terminal, the invention is not limited to this form, and the information terminal may be a cellular phone, a PDA, a notebook PC. While a server apparatus will be described by the use of a server as an example, the server apparatus is not limited to this server, and any device will do such as a PC, a game machine, and a household electronic product including a television receiver (TV) and a DVD recorder as long as it has a server function. Further, a portable terminal may be a server apparatus as long as the portable terminal has a server function.

### First Embodiment

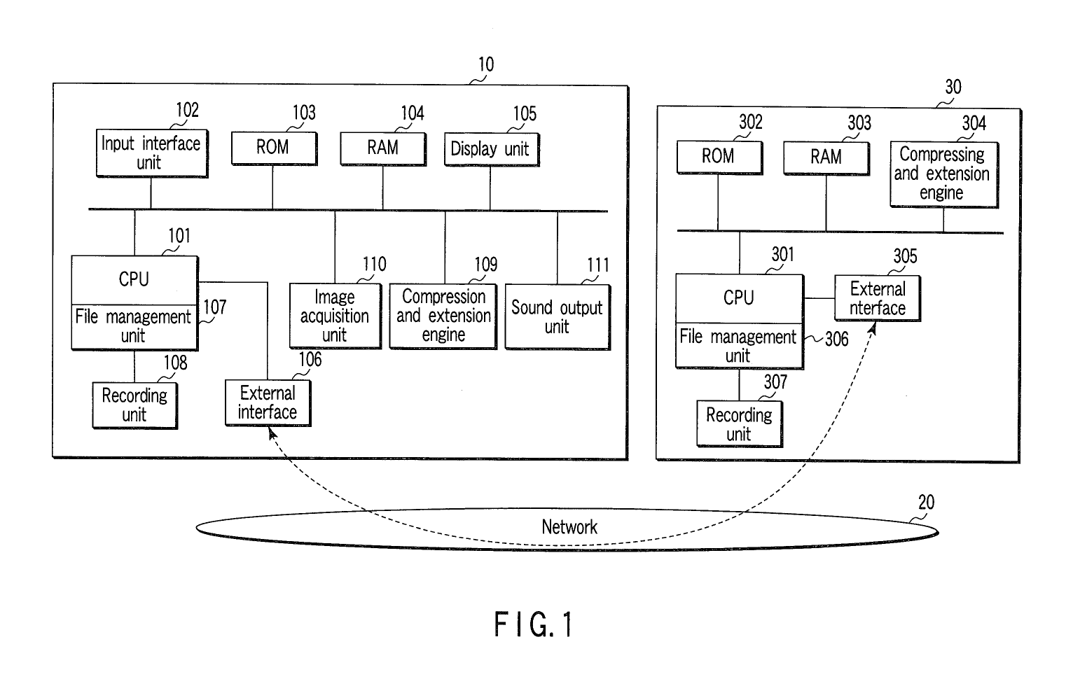

As shown in FIG. 1, the information processing system includes a digital still camera (DSC) 10 as an information terminal, and a server 30 as a server apparatus to be connected to the DSC 10 through a network 20.

The DSC 10 includes a CPU 101, an input interface unit 102, a ROM 103, a RAM 104, a display unit 105, an external interface 106, a file management unit 107, a recording unit 108, a compression and extension engine 109, an image acquisition unit 110, and a sound output unit 111.

The CPU 101 performs various controls by using the RAM 104 in accordance with a control program stored in the ROM 103. The CPU 101 is connected to the network 20 via the external interface 106 by a wired or a wireless network protocol, and is configured to communicate with the server 30 disposed outside. Data to be transmitted and received in communicating with the server 30 disposed outside is stored in the RAM 104. The recording unit 108 is a recording medium such as a semiconductor memory, a magnetic memory, a magnetic disk, an optical disk, a magneto-optical disk, or recording media not necessarily these media and capable of recording information, and a combination of the foregoing recording media can be used.

Further, there is no need for the recording unit 108 to be configured by only a single recording medium, and the recording unit 108 can be configured by a plurality of recording media. The input interface 102 is an operation input unit such as a switch, a button, a key and a dial to conduct an operation input regarding the DSC 10. The input interface unit 102 may be a touch panel, etc., overlapped on the display unit 105.

In the DSC 10 configured as mentioned above, the CPU 101 takes in acquired image data from the image acquisition unit 110 in accordance with the input interface unit 102 to store the data on the RAM 104. The CPU 101 issues a compression instruction to the compression and extension engine 109, and the engine compresses the acquired image data on the RAM 104 to an image on a format specified by the CPU 101. The compressed image is recorded in the recording unit 108 through the file management unit 107 in accordance with the instruction from the CPU 101.

Thus, in reproducing the image recorded in the recording unit 108, at first, the image in the recording unit 108 is opened through the file management unit 107 in accordance with the instruction from the CPU 101, and the engine 109 extends the image in accordance with the recorded format. The extended image data is reproduced on the display unit 105.

Meanwhile, the server 30 includes a CPU 301, a ROM 302, a RAM 303, a compression and extension engine 304, an external interface 305, a file management unit 306 and a recording unit 307.

The CPU 301 conducts various controls by using the RAM 303 in accordance with the control program stored in the ROM 302 and the recording unit 307. The COU 301 is connected to the network 20 via the external interface 305 though a wired or a wireless network protocol and is configured to make communication with the DSC 10 disposed outside. The data to be transmitted and received in communication with the server 30 disposed outside is stored in the RAM 303.

Next, an operation outline of the information processing system configured as mentioned above will be described.

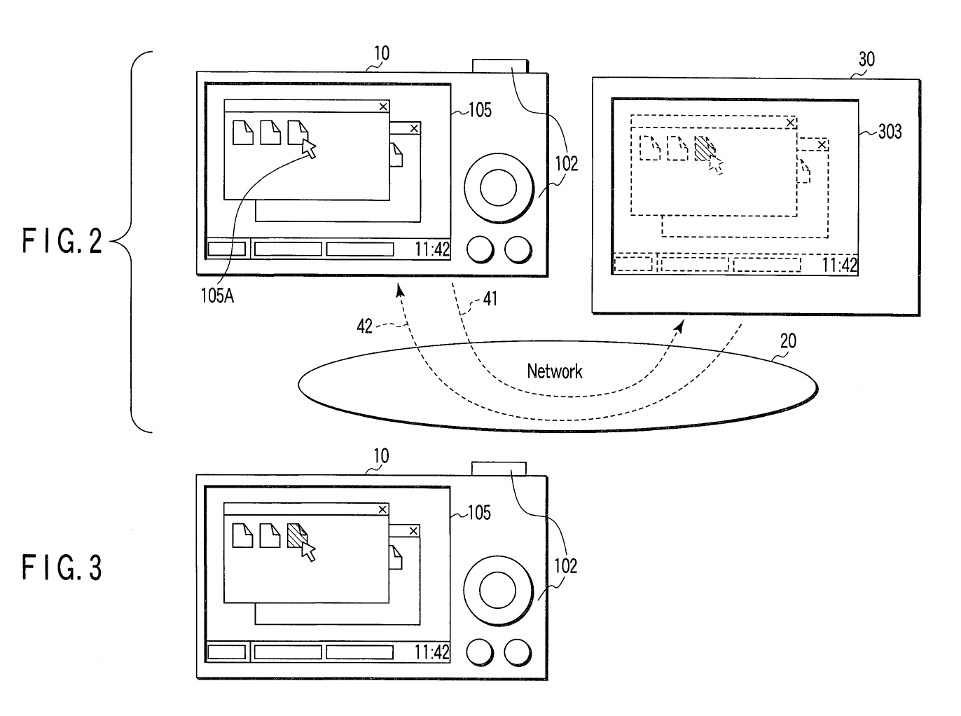

As shown in FIG. 2, an input instruction input by a user by using the input interface unit 102 of the DSC 10 is transmitted to the server 30 via the network 20, as operation input information 41. An image on a screen (screen data) to be displayed on the display unit 105 of the DSC 10 is stored in the RAM 303 of the server 30. The image on the screen stored in the RAM 303 is appropriately updated in response to the internal processing of the server 30, or in response to the operation input information 41 to be received from the DSC 10 via the network 20.

Meanwhile, an image of a screen stored in the RAM 303 of the server 30 is transmitted to the DSC 10 via the network 20, as processing result information 42 that is the screen data of the screen to be displayed on the display unit 105 of the DSC 10. The processing result information 42 may be content of a still image, moving images, etc., in which the image on the screen is converted, and may be a drawing command to make the DSC 10 draw the content. The processing result information 42 may further include sound information accompanied by the screen. The transmission of the processing result information 42 to the DSC 10 may be periodically transmitted, and my be transmitted after updating the image on the screen stored in the RAM 303 in response to the operation input information 41 received from the DSC 10. The DSC 10 displays the content that is the processing result information 42 to be received via the network 20 on the display unit 105 as it is or displays the content in accordance with the drawing command by analyzing the command. If the sound information is included in the content, the sound output unit 111 reproduces and outputs the content.

For instance, it is assumed that the user inputs the “decision” by the input interface unit 102, based on the image on the screen of the server 30 displayed on the display unit 105 of the DSC 10 in FIG. 2. Thereby, the DSC 10 transmits the “decision” as the operation input information 41 to the server 30. The server 30 updates from the image on the screen stored in the RAM 30 to an image of a new screen on which a file decided at a position of a cursor 105A (a selected file is highlighted) on the basis of the “decision” of the operation input information 41. The server 30 transmits the image on the new screen as the processing result information 42 to the DSC 10. As a result, the DSC 10 displays the image on the new screen on which the selected file is highlighted on the display unit 105, as shown in FIG. 3.

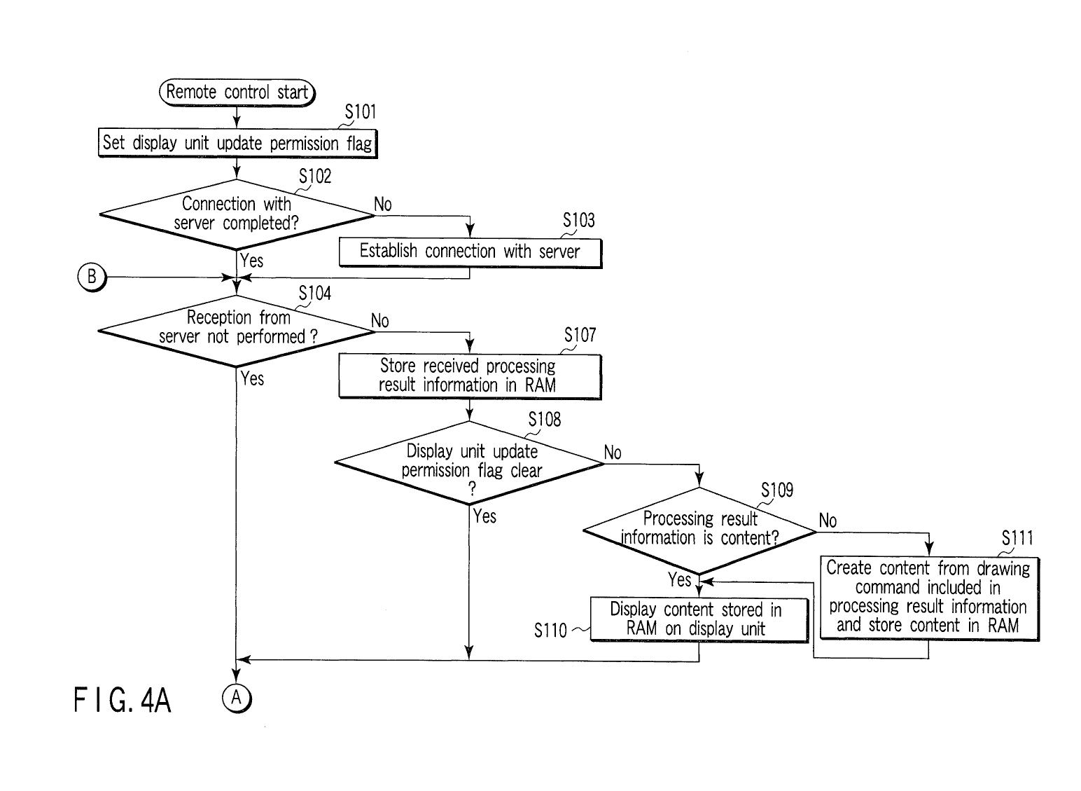

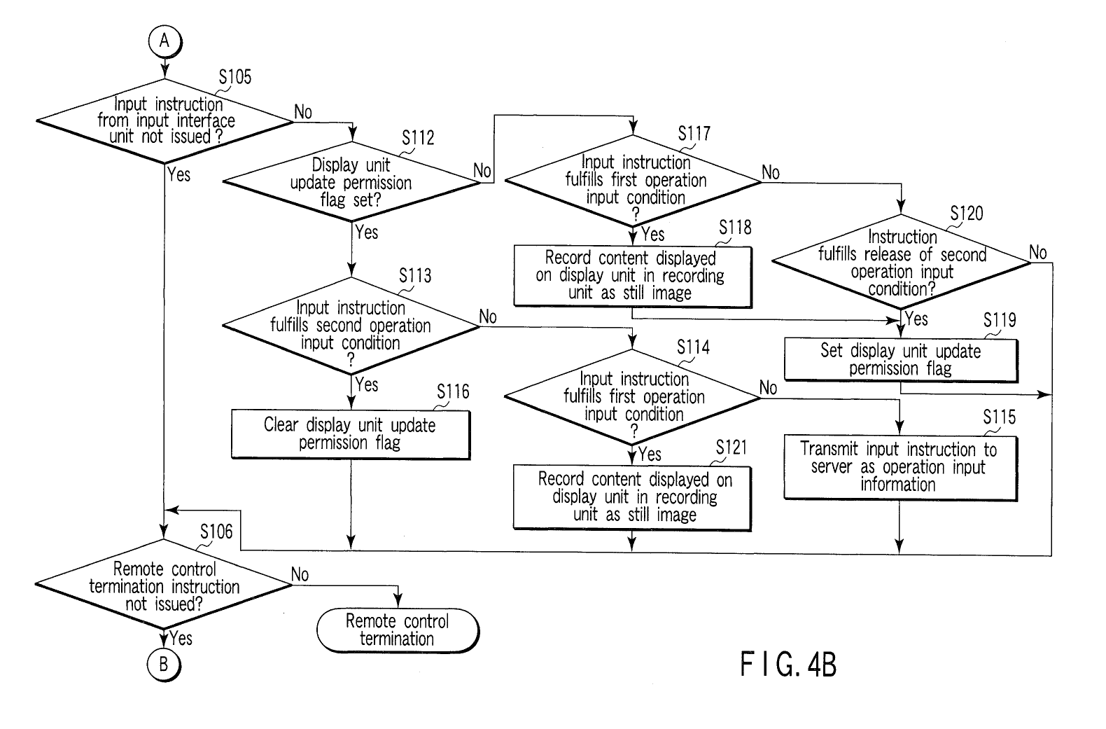

The following will describe the operation of the DSC 10 in detail by referring to FIGS. 4A and 4B. For instance, the user issues a start instruction for a remote control from the input interface 102, or receives a remote control start instruction from the server 30 by the external interface 106 via the network 20. The CPU 101 then firstly sets a display unit update permission flag (not shown) disposed in the CPU 101 or in the RAM 104 (Step S101). After this, the CPU 101 determines whether or not the connection to the server 30 has been already completed (Step S102). For instance, if the user issues the start instruction of the remote control from the interface unit 102, it is determined that the connection with the server 30 has not been completed yet. When it is determined that the connection with the server 30 has not been completed, the CPU 101 establishes connection to the server 30 through the external interface 60 via the network 20 (Step S103).

Meanwhile, for example, when receiving the remote control start instruction from the server 30 via the network 20, the CPU 101 determines that the connection to the server 30 has been completed in step S102. In this way, if it is determined that the connection to the server 30 has been completed, or after the connection to the server 30 has been established in Step S103, the CPU 101 determines whether or not reception of the processing result information 42 from the server via the network 20 is performed (Step S104). Here, if the CPU determines that the reception of the result information 42 from the server 40 has not been performed, the CPU 101 further determines the presence or absence of the input instruction by the user through the interface unit 102 (Step S105). If it is determined that the input instruction from the interface unit 102 is also not issued, the CPU 101 further determines whether or not a remote control termination instruction from the interface unit 102 or a remote control termination instruction from the server 30 via the network 20 is not issued (Step S106). Here, if the remote control termination instruction is issued, the DSC 10 terminates the operations by the remote control program. Conversely, if the remote control termination instruction is not issued, the DSC 10 returns to Step S104 to repeat the foregoing processing.

On the contrary, in Step S104, if it is determined that the reception of the result information 42 from the server 30 has been performed, the CPU 101 stores the received result information 42 in the RAM 104 (Step S107). The CPU 101 then determines whether or not the update permission flag is cleared (Step S108). Here, if it is determined that the update permission flag is set, the CPU 101 further determines whether or not the processing result information 42 stored in the RAM 104 is content capable of being displayed as it is (Step S109).

Here, the result information 42 to be transmitted from the server 30 may be converted content, and may be the drawing command. The converted content means, for example, content in which the image of the screen stored in the RAM 303 of the server 30 is converted into still images such as JPEGs or moving images such as MPEGs. The drawing command is a command to form the image on the screen stored in the RAM 303 in the server 30 of the DSC 10. An example of the drawing command is disclosed in FIG. 15 in U.S. Pat. No. 6,448,958.

If it is determined that the result information 42 stored in the RAM 104 is the content, the CPU 101 displays the content stored in the RAM 104 on the display unit 105 (Step S110). If the content includes information of a sound, the sound output unit 111 reproduces and outputs the content as a sound.

Conversely, if it is determined that the result information 42 stored in the RAM 104 is not the content, the CPU 101 creates content from the drawing command included in the result information 42 to store the content in the RAM 104 (Step S111). The DSC 10 proceeds to Step 110 and displays the content created and stored content in the RAM 104 on the display unit 105.

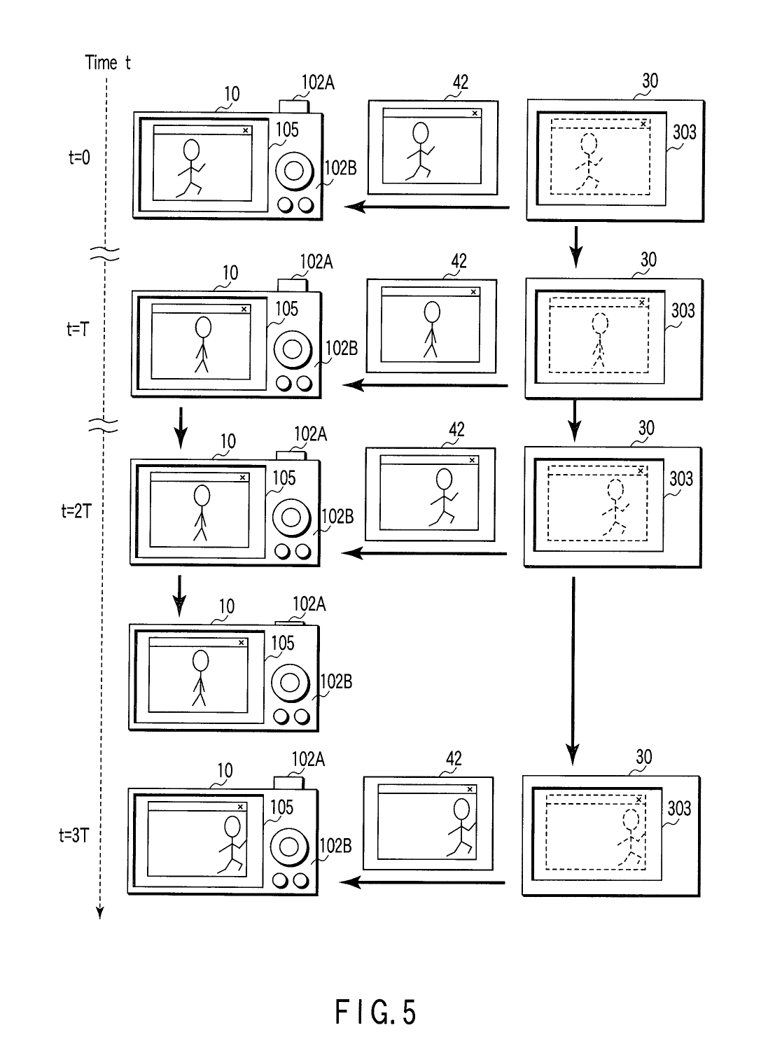

For instance, the server 30 internally reproduces the moving images as shown in FIG. 5, and updates the screen through the internal processing. The result information 42 is transmitted to the DSC 10 for each predetermined interval [T]. The DSC 10 displays the result information 42 to be received for each predetermined interval [T] on the display unit 105 as the content. That is, the content received at a point of time of t=0 is displayed until a point of time of t=T, a new content is received at the point of time of t=T, and the display is updated. Thus, the display is updated for each predetermined point of time.

In Step S105, if it is determined that the input instruction has been issued from the input interface unit 102, the CPU 101 determines whether or not the update permission flag is set (Step S112). Here, if it is determined that the update permission flag is set, the CPU 101 further determines whether or not the input instruction fulfills a second operation input condition (Step S113). If the input instruction does not fulfills the second operation input condition, the CPU 101 determines whether or not the input instruction fulfills a first operation input condition (Step S114). In this embodiment, it is assumed that the second operation input condition is satisfied when a two-stage pushbutton switch 102A at the input interface unit 102 of the DSC 10 (refer to FIG. 5) is pushed up to a first stage of a pushbutton operation (hereinafter, referred to ‘half push’). It is assumed that the first operation input condition is satisfied when the pushbutton switch 102A is pushed up to a second stage of the pushbutton operation (hereinafter, referred to ‘full push’). Therefore, when an operation of a key unit 102B of a cross key, etc., at the interface unit 102, the CPU 101 determines that the input instruction is not instruction of the first operation input condition. In this way, if it is determined that the input instruction is also not the first operation input condition, the CPU 101 transmits the input instruction as the operation input information 41 to the server 30 via the network 20 through the external interface 106 (Step S115). Then the DSC 10 proceeds to Step S106.

On the contrary, if it is determined that the input instruction is the second operation input condition in Step S113, the DSC 10 clears the update permission flag (Step S115), and proceeds to Step S106. After clearing the update permission flag (Step S116), the DCS 10 proceeds to Step S106. Thus, after clearing the update permission flag, when the DSC 10 proceeds to Steps S106, S104, S107, it is determined that the update permission flag has been cleared in Step 108. Therefore, in this case, the processing from Steps S109 to S111 is not performed, and the display on the display unit 105 is not updated.

For instance, it is assumed that the two-stage pushbutton switch 102A is pushed in the ‘half push’ manner for a time interval from the point of time of t=T to a point of time of t=2T and the second operation input condition is satisfied. In this case, at the point of time of t=2T, a screen which has been updated by the internal processing of the server 30 is transmitted as the processing result information 42, and the DSC 10 receives the screen. However, in this case, the received result information 42 is only stored in the RAM 104, and the result information 42 does not update the display on the display unit 105. That is, the display unit 105 keeps the display of the content based on the processing result information 42 received at the point of time of t=T. In other words, the display is fixed. In this way, if the two-stage pushbutton switch 102A of the DSC 10 is pushed in the ‘half push’ manner, even when new processing result information 42 is received, the display on the display unit 105 is not updated.

If the button switch 102A of the DSC 10 is pushed in the ‘full push’ manner, and when the DSC 10 proceeds from Step S105 to Step S112, since the update permission flag is cleared in Step S116, it is determined that the update permission flag has not been set. In this case, the CPU 101 determines whether or not the input instruction is the first operation condition (Step S117). If it is determined that the input instruction is the first operation input condition, the file management unit 107 records the content in display on the display unit 105 as a still image in the recording unit 108 (Step S118). In this case, the still image may be recorded after the compression by the compression and extension engine 109. The DSC 10 then sets the update permission flag (Step S119) and proceeds to Step S106.

For instance, when the two-stage pushbutton 102A is fully pushed for a period from a point of time of t=2T to a point of time of t=3T and the first operation input condition is satisfied, the display content which has been fixed by the ‘half-push’ of the button switch 102A is recorded as the still image.

After the recording in this way, since the update permission flag is set in Step S119, when the DSC 10 proceeds to Steps S106, S104, S107 and S108, it is determined the update permission flag has been set in Step S108. Thus, the DSC 10 performs the processing in Steps 109 to S111 and updates the display.

For instance, it is assumed that for the time period from the point of time of t=2T to the point of time t=3T, the button switch 102A is fully pushed and the still image is recorded. In this case, at the point of time of t=3T, a screen which has been updated by internal processing of the server 30 is transmitted as the processing result information 42, then the DSC 10 receives the result information 42. The DSC 10 stores the received result information 42 in the RAM 104 and updates the display of the content on the basis of the result information 42. In this way, after the button switch 102A is fully pushed, the DSC 10 restarts the update of the display on the display unit 105 by the result information 42 to be received.

If it is determined that the input instruction is not the first operation input condition in Step S117, the CPU 101 further determines whether or not the input instruction fulfills the release from the second operation input condition (Step S120). If the input instruction does not fulfill the release from the second operation input condition, the DSC 10 proceeds to Step S106, and if the input instruction fulfills the release therefrom, the DSC 10 proceeds to Step S119. That is, if the button switch 102A has been released from the half-pushed state without being fully pushed from the state in which the button switch 102A is half-pushed, the DSC 10 proceeds from Step S117 to Step S120, and it is determined that the input instruction fulfills the release from the second operation input condition in Step S120. Then, in Step S119, the display unit update permission flag is set. Therefore, after the release from the half-pushed state of the button switch 102A, the display update for every predetermined interval is restarted. Conversely, if the key unit 102B such as the cross key, of the interface unit 102 is operated without a full-pushed state of the button switch 102A from the state in which the button switch 102A is half-pushed, the transmission of the operation input information by the operation is not posed.

If it is determined that the input instruction does not fulfill the first operation input condition in Step S114, the DSC 10 records the content being in display on the display unit 105 in the recording unit 108 as the still image (Step S121), and then, proceeds to Step S106. That is, if the button switch 102A is immediately fully pushed without being half-pushed, the still image is immediately recorded without fixing the display. In this case, since the recording is implemented without the processing to clear the permission flag in Step S116, there is no need to set the permission flag after the recording as in Steps S118, S119.

As given above, according to the first embodiment, the DSC 10 may fix and record the processing result information 42 of the server 30 to be displayed on the DSC 10 at the timing desired by the user. Therefore, the user may easily confirm the processing result information 42 and may easily reuse the result information 42.

The transmission of the operation input information is not generated for the time period from the satisfaction of the second operation input condition to the satisfaction of the first operation input condition, or until the release from the second operation input condition. Therefore, since the number of times of the transmissions and receptions between the DSC 10 and the server 30, there will be room in a network band, and the DSC 10 may extend the driving time period.

Further, since a means having an equal part to a generic image acquisition means in the DSC 10 may fix and record the result information 42, a method for fixing and recording the result information 42 which is intuitively and easily understood by the user can be provided.

### Second Embodiment

The following will describe the second embodiment of the invention. While the first embodiment has described the case in which even when the processing result information 42 is received, the display is not updated, the second embodiment does not update the display by not transmitting the result information 42 even if the screen is updated by the internal processing of the server 30.

Since the configuration of the information processing system regarding the embodiment is similar to that of the first embodiment, the description of the configuration will be omitted.

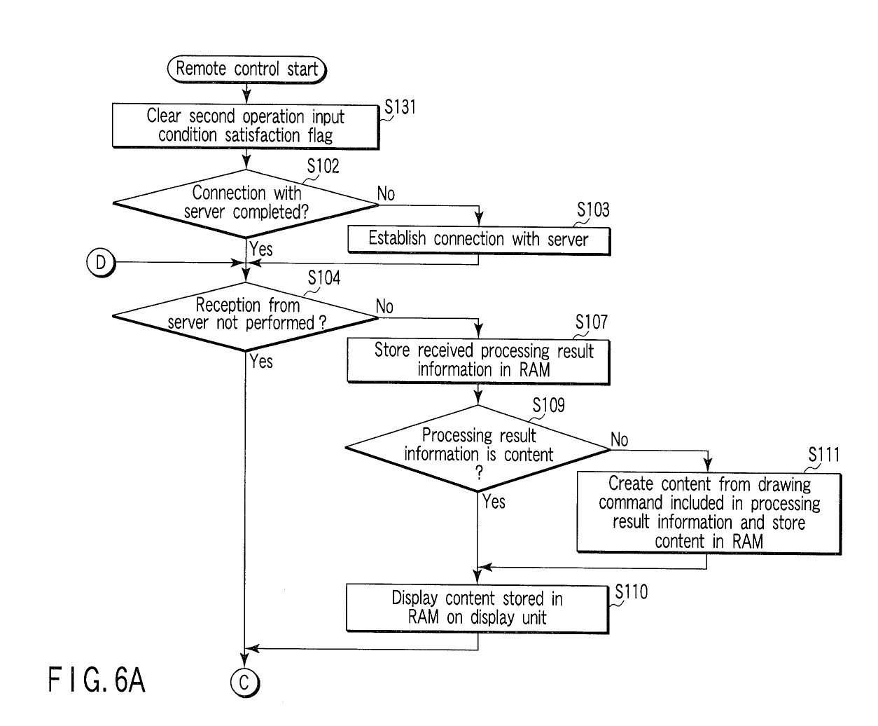

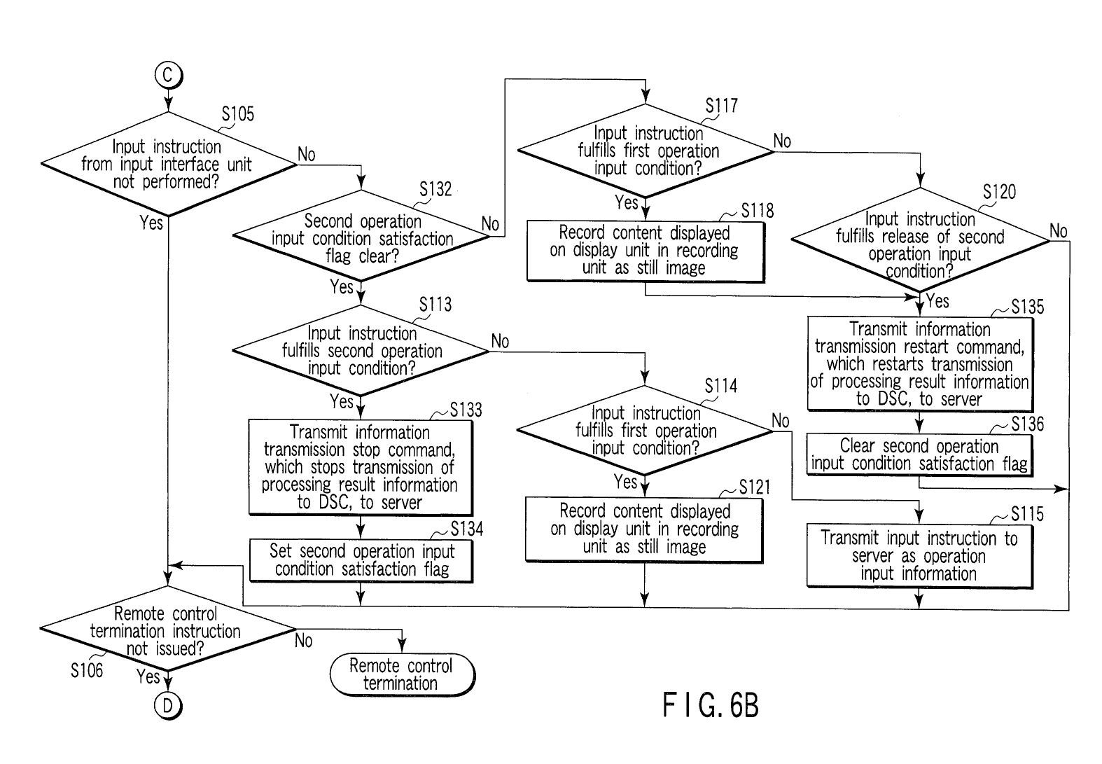

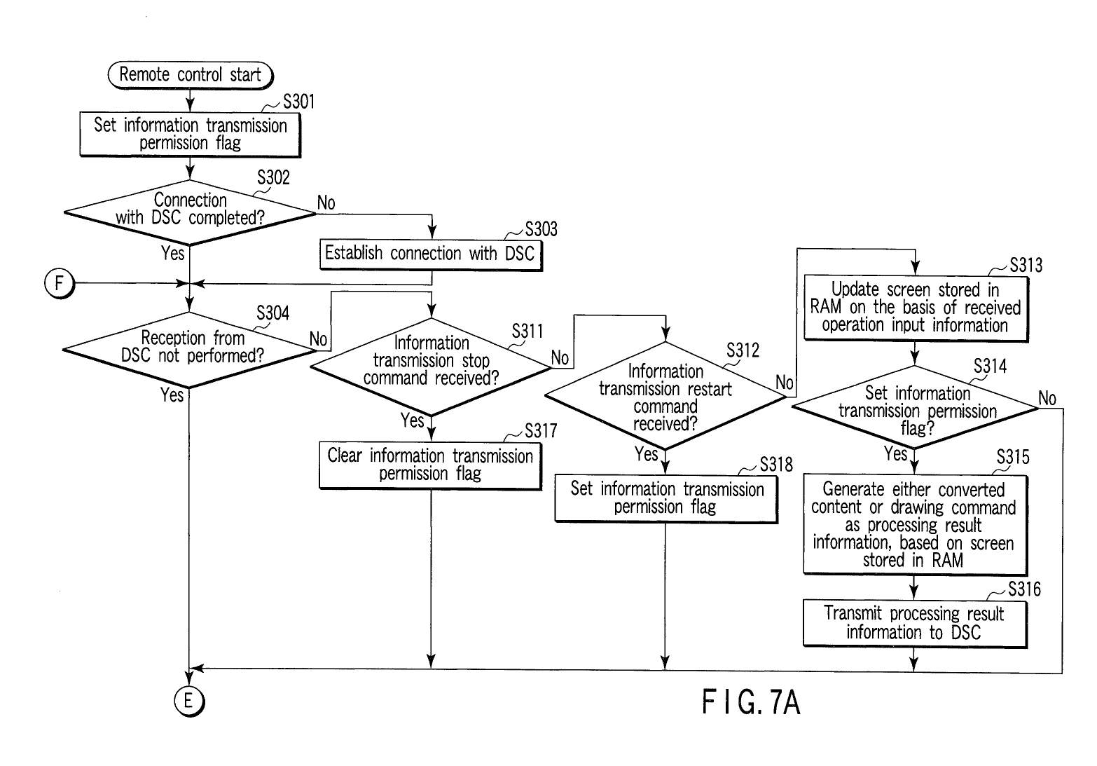

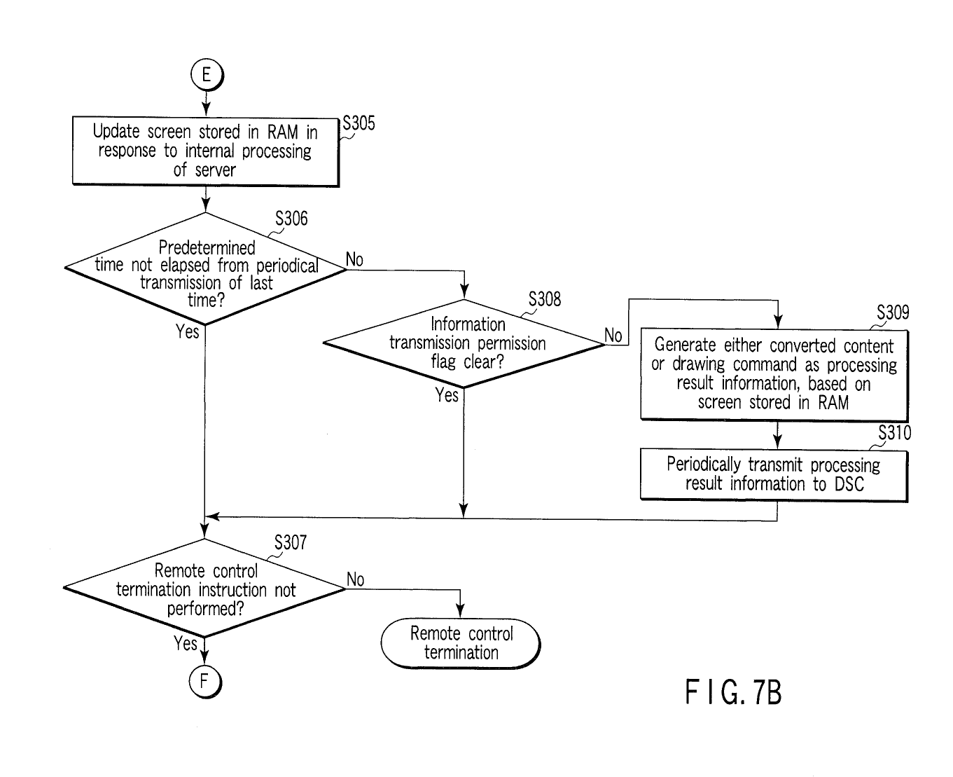

Hereinafter, operations of the DSC 10 and the server 30 of the embodiment will be described in detail with reference to FIGS. 6A, 6B, 7A and 7B. Here, in FIGS. 6A and 6B, the processing similar to the first embodiment is designated by the identical symbols shown in FIGS. 4A and 4B. In the embodiment, it is also assumed that the second operation input condition is satisfied when the two-stage pushbutton switch 102A at the input interface unit 102 of the DSC 10 is half-pushed and the first operation input condition is satisfied when the button switch 102A is fully pushed. In the embodiment, as long as a special command is issued, the processing result information 42 is transmitted to the DSC 10 for each predetermined interval [T].

In other words, in the DSC 10, for example, a user issues a start instruction for remote control from the input interface unit 102. Or, the DSC 10 receives the start instruction for the remote control from the server 30 through the external interface 106 via the network 20. In response to this, the CPU 101 firstly clears a second operation input condition satisfaction flag (not shown) disposed in the CPU 101 or in the RAM 104 (Step S131). After this, the CPU 101 determines whether or not the connection to the server 30 has been completed (Step S102). Here, if it is determined that the connection to the server has not been completed (namely, for example, the user issues the start instruction from the input interface unit 102), the CPU 101 established the connection with the server 30 via the network 20 through the external interface 106 (Step S103).

Meanwhile, in the server 30, for instance, the manager of the server 30 issues the start instruction for the remote control from an input interface unit (not shown), or the server 30 receives the start instruction for the remote control from the DSC 10 via the network 20. In response to this, the CPU 301 firstly sets an information transmission permission flag (not shown) disposed in the CPU 301 or in the RAM 303 (Step S301). After this, the CPU 301 determines whether or not the connection with the DSC 10 has been completed (Step S302). Here, if the connection with the DSC 10 has not been completed (namely, for example, the manager issues the start instruction for the remote control from the input interface unit), the CPU 301 establishes the connection to the DSC 10 via the network 20 through the external interface 305 (Step S303).

In the DSC 10, if the start instruction for the remote control is received from the server 30 via the network 20, it is determined that the connection to the server 30 has been connected to the server 30 in Step S102. In this way, if it is determined that the DSC 10 has been connected to the server 30, or after establishing the connection to the server 30 in Step S103, the CPU 101 determines whether or not the processing result information 42 has been received from the server 30 (Step S104). Here, if it is determined that the result information 42 has not been received from the server 30, the CPU 101 further determines whether or not the input instruction has been issued by the user from the input interface 102 (Step S105). If it is determined that the input instruction from the interface unit 102 also has not been received, the CPU 101 further determines whether or not the remote control termination instruction from the interface unit 102, or the remote control termination instruction from the server 30 via the network 20 has not been received (Step S106). Here, if the remote control instruction has been received, the CPU 101 terminates the operations through the remote control program. Conversely, if the remote control termination instruction has not been received, the DSC 10 returns to Step S104 to repeat the foregoing processing. If the operations through the remote control program has been started, for example by the start instruction for the remote control by the user from the input interface unit 102, the DSC 10 may transmit the remote control termination instruction to the server 30 from the external interface 106 via the network 20 in the foregoing termination.

Meanwhile, in the server 30, for example when receiving the remote control start instruction from the DSC 10 via the network 20, it is determined that the server 30 has already been connected to the DSC 10. In this way, if it is determined that the server 30 has already been connected to the DSC 10, or in Step S303, after establishing the connection to the DSC 10, the CPU 301 determines whether or not the reception form the DSC 10 has been performed (Step S304). Here, if the CPU 301 has determined that the reception from the DSC 10 has not been performed, the CPU 301 updates the screen stored in the RAM 303 or creates the screen corresponding to the internal processing of the server 30 to store the screen in the RAM 303 (Step S305). That is, even if the operation input information 41 from the DSC 10 is not received, since the screen of the server 30 may be changed at every moment, the CPU 301 updates the screen stored in the RAM 303 in Step S305. For instance, in the case in which the server 30 generates a screen including moving image reproduction, even when the input from the DSC 10 has not been performed, the screen is changed at every moment in response to the reproduced moving images. Other than this, the screen including a game screen, the screen including a reproduction time counter of a music player, etc., are changed in a similar manner.

After the update of the screen such as mentioned above, the CPU 301 determines whether or not a predetermined time (a predetermined interval [T]) has elapsed (Step S306). If the server 30 has determined that the prescribed time [T] has not elapsed, the CPU 301 further determines whether or not a remote control termination instruction is issued from an input interface unit (not shown), or a remote control termination instruction is issued from the DSC 10 via the network 20 (Step S307). Here, if the remote control termination issue has been performed, the server 30 terminates the operation through the remote control program. Conversely, if the remote control termination instruction has not been issued, the DSC 10 returns to Step S304 and repeats the foregoing processing. If the operation is started in accordance with the remote control start instruction by the manager from the input interface unit (not shown), the information processing system may transmit the remote control termination instruction to the DSC 10 from the external interface 305 via the network 20 at the time of the foregoing termination.

If it is determined that the predetermined time (the predetermined interval [T]) has elapsed in Step S306, the CPU 301 determines whether or not the information transmission permission flag is tuned off (Step S308). Here, if it is determined that the information transmission permission flag is set, the server 30 generates the converted content or the drawing command as the processing result information 42 on the basis of the screen stored in the RAM 303 (Step S309). The server 30 transmits the generated processing result information 42 to the DSC 10 through the external interface 305 (Step S310) then proceeds to Step S307.

When the processing result information 42 has been transmitted in Step S310, the DSC 10 determines, in Step S104, that the reception from the server 30 has been performed. As mentioned above, if it is determined that the reception form the server 30 has been performed, the CPU 101 stores the received processing result information 42 in the RAM 104 (Step S107). The CPU 101 then determines whether or not the processing result information 42 stored in the RAM 104 is the content which can be displayed as it is (Step S109). Here, if it is determined that the stored processing result information 42 is the content, the stored content is displayed on the display unit 105 (Step S110). If the content includes the information on a sound, the sound output unit 111 reproduces and outputs the information as the sound. Conversely, if it is determined that the processing result information 42 stored in the RAM 104 in Step S109, the CPU 101 generates content from a drawing command included in the processing result information 42 to store the content in the RAM 104 (step S111). Then, the DSC 10 proceeds to Step S110 and displays the content generated and stored in the RAM 104 on the display unit 105.

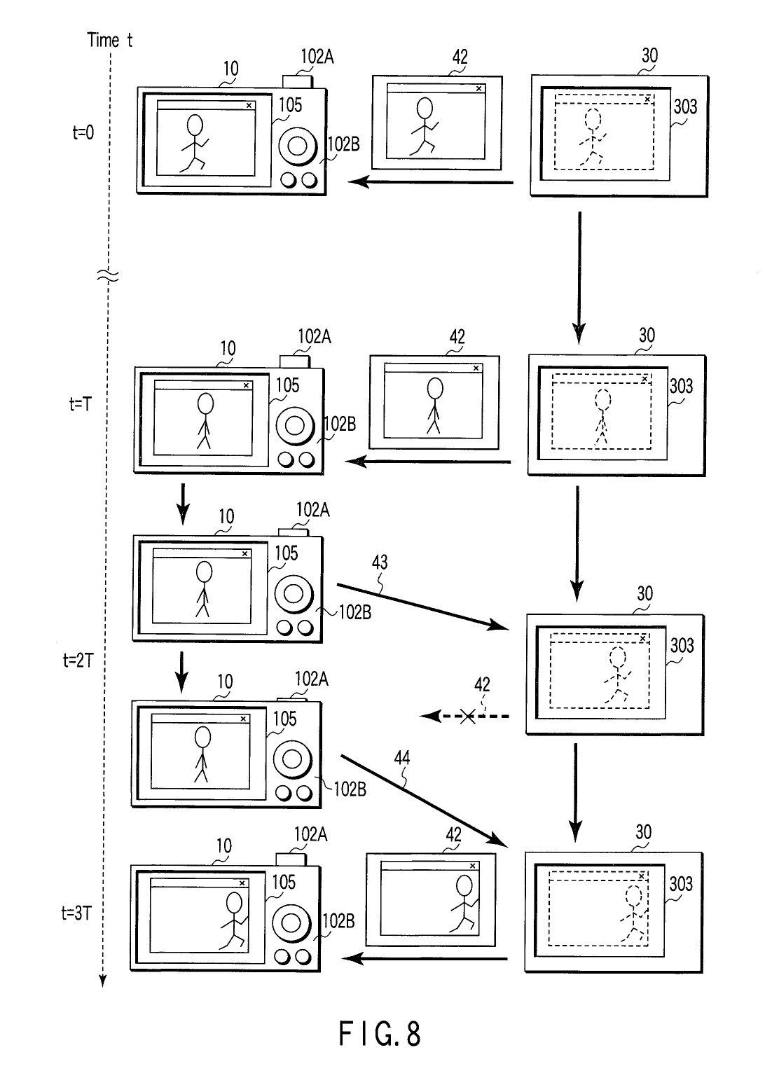

For instance, as shown in FIG. 8, the server 30 internally reproduces the moving images and updates the screen by the internal processing. The server 30 transmits the processing result information 42 to the DSC 10 for every predetermined interval [T]. The DSC 10 displays the processing result information 42 to be received for every predetermined interval [T] on the display unit 105 as the content. That is, the content which has been received at the point of time of t=0 is displayed up to the point of time of t=T, the new content is received at the point of time of t=T, and the display is updated at that time. In this way, the display is updated at every predetermined time.

In Step S105, if the DSC 10 determines that the input instruction from the input interface unit 102 has been performed, the DSC 10 determines whether or not the second operation input condition satisfaction flag is cleared (Step S132). Here, if it is determined that the second operation input condition satisfaction flag is cleared, the DSC 10 further determines whether or not the input instruction fulfills the second operation input condition (Step S113). If it is determined that the input instruction does not fulfill the second operation input condition, the DSC 10 further determines whether or not the input instruction fulfills the first operation input condition (Step S114). If it is determined that the input instruction does not fulfill the first operation input condition, the DSC 10 determines that the input instruction is issued by the operation of the key unit 102B such as the cross key, of the input interface unit 102. The DSC 10 transmits the input instruction as the operation input information to the server 30 through the external interface 106 via the network 20 (Step S115) then proceeds to Step S106.

When transmitting the operation input information 41 in Step S115, the server 30, in Step S304, determines that the reception from the DSC 10 is performed. In this way, if the server 30 determines that the reception from the DSC 10 is performed, the CPU 301 determines whether or not an information transmission stop command that is a command to stop the transmission of the processing result information 42 to the DSC 10 is received (Step S311). Here, if the CPU 301 determines that the information transmission stop command is not received, the CPU 301 further determines whether or not an information transmission restart command that is a command to restart the transmission of the processing result information 42 to the DSC 10 is received (Step S312). If it is determined that the information transmission restart command that is the command to restart the transmission of the processing result information 42 to the DSC 10 is not also received, the CPU 301 determines the reception of the operation input information 41 is performed. Based on the received operation input information 41, the CPU 301 updates the screen stored in the RAM 303 or the CPU 301 creates the screen, based on the received operation input, to store the screen in the RAM 303 (Step S313). After this, the CPU 301 determines whether or not the transmission permission flag is set (Step S314). If it is determined that the transmission permission flag is set, the CPU 301 generates the converted content or the drawing command as the processing result information 42 on the basis of the screen stored in the RAM 303 (Step S315). The server 30 transmits the generated processing result information 42 to the DSC 10 through the external interface 305 via the network 20 (Step S316) then proceeds to Step S305.

When the transmission of the processing result information 42 is performed in Step S316, the DSC 10 proceeds from Step S104 to Steps S107 and S109 as mentioned above. The content is displayed on the display unit 105 in Step S110 or Steps S111 and S110.

Conversely, in Step S113, if it is determined that the input instruction fulfills the second operation condition, the CPU 101 of the DSC 10 operates as follows. That is, the CPU 101 transmits the information transmission stop command that is the command to stop the transmission of the processing result information 42 to the DSC 10 to the server 30 through the external interface 106 via the network (Step S133). The CPU 101 then sets the second operation input condition satisfaction flag (Step S134) and proceeds to Step S106.

Thus, when the information transmission stop command has been transmitted in Step S133, the server 30 determines that the reception from the DSC 10 has been performed in Step S304, and determines that reception of the information transmission stop command has been performed in Step S311. The CPU 301 then tunes off the information transmission permission flag (Step S317) and proceeds to Step S305. In Step S305, the CPU 301 updates the screen stored in the RAM 303 in response to the internal processing of the server 30, or creates the screen corresponding to the internal processing of the server 30 to store the screen in the RAM 303, and then, the server 30 proceeds from Step S306 to Step S308. In Step S308, it is determined that the information transmission permission flag is tuned off. In this way, if it becomes clear that the information transmission permission flag is cleared, the CPU 301 does not perform the processing in Steps S309, S310 as given above, and immediately proceeds to Step S307. That is, the creation and the transmission of the processing result information 42 on the basis of the screen stored in the RAM 303 are not performed.

For instance, if the second operation input condition is satisfied by the two-stage pushbutton switch 102A being half-pushed for a time period from the point of time of t=T to the point of time of t=2T and the second operation input condition is satisfied, the DSC 10 transmits the information transmission stop command 43 to the server 30. Thereby, even if the server 30 has already internally processed to update the screen at the point of time of t=2T, the updated screen is not transmitted as the processing result information 42. Therefore, the display unit 105 of the DSC 10 keeps to display the content depending on the processing result information 42 received at the point of time of t=T. In other words, the display is fixed. As mentioned above, since the half-push of the button switch 102A of the DSC 10 does not newly transmit the processing result information 42, the DSC 10 does not update the display unit 105.

If the button switch 102A of the DSC 10 is fully pushed, when the CPU 101 proceeds from Step S105 to Step S132, since the second operation input condition satisfaction flag has been set, it is determined that the second operation input condition satisfaction flag is not cleared. In this case, the CPU 101 determines whether or not the input instruction means the first operation input condition (Step S117). If it becomes clear that the input instruction means the first operation input condition, the file management unit 107 records the content in display on the display unit 105 as the still image (Step S118). In such a case, the compression and extension engine 109 may records the still image after compressing the still image. The CPU 101 transmits the information transmission restart command that is the command to restart the transmission of the processing result information 42 to the DSC 10 to the server 30 through the external interface 106 via the network 20 (Step S135). After this, the CPU 101 clears the second operation input condition satisfaction flag (Step S136) to proceed to Step S106.

Thus, when the information transmission restart command has been transmitted in Step S136, the server 30 determines the reception from the DSC 10 in Step S304 then proceeds from Step S311 to Step S312. The server 30 determines the reception of the information transmission restart command in Step S312. The CPU 301 then sets the information transmission permission flag (Step S318) to proceed to Step S305. In Step S305, the CPU 301 updates the screen stored in the RAM 303, or creates the screen corresponding to the internal proceeding in the server 30 to store the screen in the RAM 303. After this, when proceeding from Step S306 to Step S308, in Step S308, the CPU 301 determines that the information transmission permission flag is set. Accordingly, the CPU 301 performs the processing in the foregoing Steps S309 and S310 then generates to transmit the processing result information 42 based on the screen stored in the RAM 303.

For instance, if the first operation input condition is satisfied by the two-stage pushbutton switch 102A is fully pushed for the time interval from the point of time of t=2T to the point of time of t=3T in FIG. 8, the display content which has been fixed by the half-push of the switch button 102A is recorded as the still image. The DSC 10 transmits the information transmission restart command 44 to the server 30 thereby the next point of time of t=3T, the screen updated through the internal processing in the server 30 is transmitted to the DSC 10 as the processing result information 42. The DSC 10 stores the processing result information 42 in the RAM 104 and updates the display of the content depending on the processing result information 42. In this way, the DSC 10 restarts the update of the display unit 105 in accordance with the received processing result information 42 after the button switch 102A is fully pushed.

In step S117, if the DSC 10 determines that the input instruction does not fulfill the first operation input condition, the DSC 10 further determines whether or not the input instruction fulfills the release of the second operation input condition (Step S120). If the input instruction does not fulfill the release of the second operation input condition, the DSC 10 proceeds to Step S106, and if the input instruction fulfills the release of the second operation input condition, the DSC 10 proceeds to Step S135. That is, if the half-push state of the two-stage pushbutton switch 102A is released without the button switch 102A fully pushed from the half-push state of the button switch 102A, the DSC 10 proceeds from Step S117 to Step S120. In Step S120, the DSC 10 determines that the input instruction fulfills the release of the second operation input condition, and in Step S135, information transmission restart command 44 is transmitted to the server 30. Therefore, after releasing the half-push state of the button switch 102A, the server 30 restarts to transmit the processing result information 42 for each predetermined time interval to the DSC 10, and the DSC 10 restarts to update the display. Meanwhile, if the key unit 102B such as the cross key, of the input interface unit 102, the transmission of the operation input information by the operation does not occur.

In Step S114, if it is determined that the input instruction does not fulfill the first operation input condition, the file management unit 107 records the content in display on the display unit 105 in the recording unit 108 as the still image (Step S121) to proceed to Step S106. That is, when the button switch 102A is immediately fully pushed without being half-pushed, the still image is immediately recorded without fixing the display. In this case, the recording does not performed through the transmission of the information transmission stop command in Step S133 and through the processing to set the second operation input condition satisfaction flag in Step S134. Accordingly, there is no need for transmitting the information transmission restart command 44 and clearing the second operation input condition satisfaction flag as in Steps S118, S135, and S136.

In Step S314, if the server 30 determines that the transmission permission flag has been cleared, the server 30 immediately proceeds to Step S305 without conducting the processing in Steps S315 and S316. That is, the server 30 does not generate and transmit the processing result information 42 on the basis of the screen stored in the RAM 303.

As mentioned above, even in the second embodiment, in the same way as that of the first embodiment, the information processing system may fix and record the processing result information 42 of the server 30 to be displayed on the DSC 10 at timing desired by the user. Therefore, the user may easily confirm the processing result information 42, and reuse the information 42.

Since the number of times of transmissions from the server 30 to the DSC 10, it is reduced for the network band to be wasted, and the saving power results in elongation of a driving time of the DSC 10.

Further, since the processing system may fix and record the processing result information 42 by a means having a common part with a generic image acquisition means of the DSC 10, the second embodiment may provide a fixing and recording methods for the processing result information 42 which is viscerally and easily understood by the user.

### Third Embodiment

Next, the third embodiment of the invention will be described. While the first and the second embodiments have recorded the processing result information at the timing desired by the user, the third embodiment records a series of items of the processing result information at timing desired by the user.

Since the configuration of the information processing system regarding the third embodiment is the same as that of the first embodiment, the description will be eliminated.

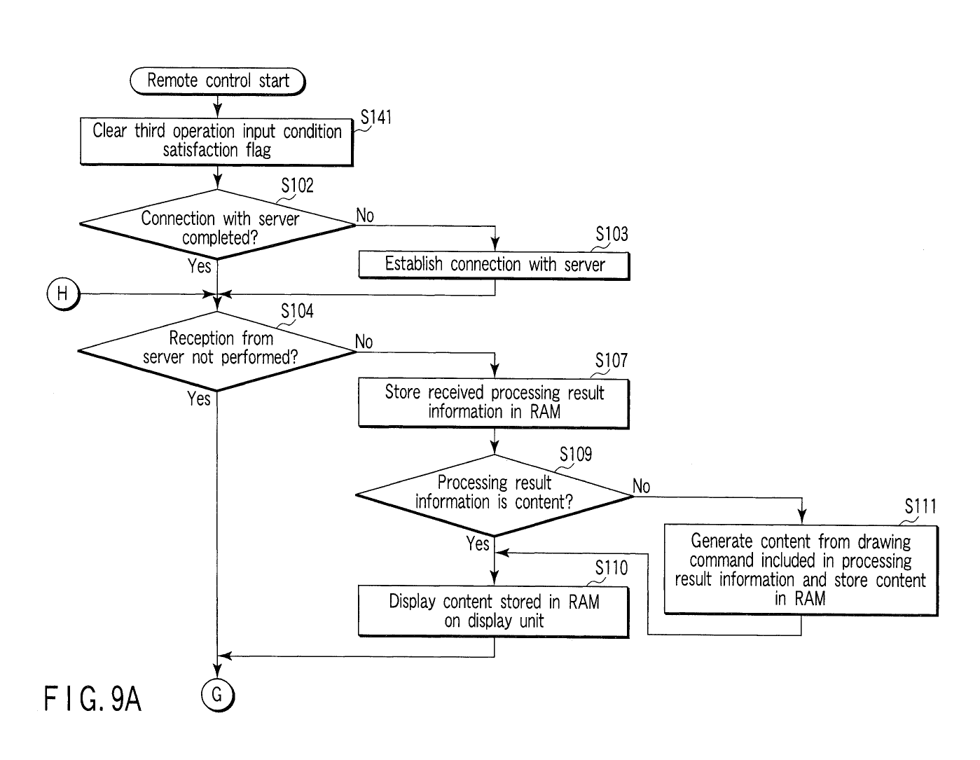

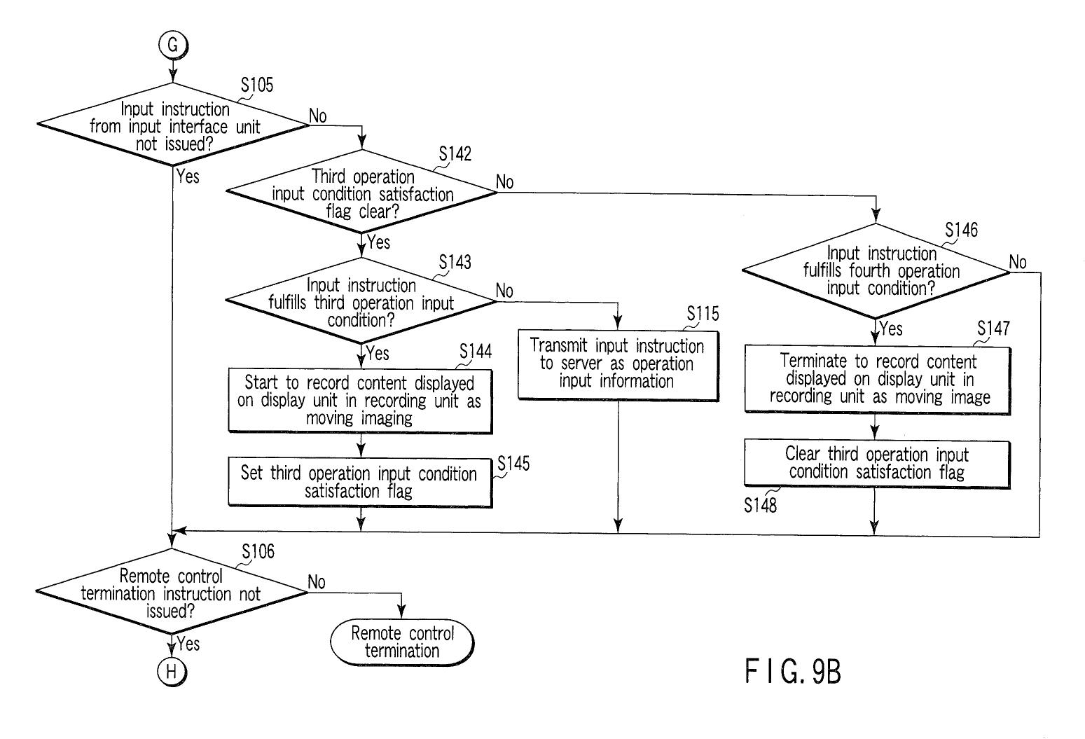

Hereinafter, operations of the DSC 10 of the third embodiment will be described in detail by referring to FIGS. 9A and 9B. Here, in FIGS. 9A and 9B, the same processing as that of the first embodiment is designated by the identical symbols in FIGS. 4A and 4B.

In other words, in the DSC 10, the user performs, for example, a start instruction for remote control from the input interface unit 102, or the external interface 106 receives a remote control start instruction from the server 30 via the network 20. In response to the reception, the CPU 101 firstly clears a third operation input condition satisfaction flag (not shown) disposed in the CPU 101 or in the RAM 104 (Step S141). After this, the CPU 101 determines whether the connection with the server 30 has been established or not (Step S102). Here, if the CPU 101 determines that the connection with the server 30 has not been established (namely, for instance, if the user issues the start instruction of the remote control from the input interface unit 102), the CPU 101 establishes the connection to the server 30 via the network 20 by the external interface 106 (Step S103).

Conversely, for instance, when receiving the start instruction of the remote control from the server 30 via the network 20, the CPU 101 determines that the connection to the server 30 has been established in Step S102. In this way, if it is determined that the connection with the server 30 has been established, or after confirming the connection with the server in Step S103, the CPU 101 determines whether or not the reception of the processing result information 42 from the server 30 via the network 20 is performed (Step S104). Here, if the CPU 101 determines that the reception of the processing result information 42 from the server 30 is not performed, the CPU 101 further determines the presence or absence of the input instruction by the user from the input interface 102 (Step S105). If it is also determined that the input instruction from the input interface unit 102 is not issued, the CPU 101 further determines whether or not the remote control termination instruction from the interface unit 102 or the remote control termination instruction from the server 30 via the network 20 (Step S106). Here, if the remote control termination instruction is issued, the operations by the remote control program are terminated. Conversely, if the remote control termination instruction is not issued, the DSC 10 returns to Step S104 to repeat the processing.

Conversely, in Step S104, if it is determined that the reception of the processing result information 42 from the server 30 has been performed, the received processing result information 42 is stored in the RAM 104 (Step S107). The CPU 101 determines whether or not the processing result information 42 stored in the RAM 104 is the content capable of being displayed as it is (Step S109). Here, if the processing result information 42 stored in the RAM 104 is such content, the CPU 101 displays the content stored in the RAM 104 on the display unit 105 (Step S110). If the content includes the information about the sound, the sound output unit 111 reproduces to output the content as the sound. Conversely, if it is determined that the processing result information 42 stored in the RAM 104 in not the content in Step S109, the CPU 101 creates content from a drawing command included in the processing result information 42 to store the created content in the RAM 104 (Step S111). The DSC 10 proceeds to Step S110 to display the content created and stored in the RAM 104 on the display unit 105.

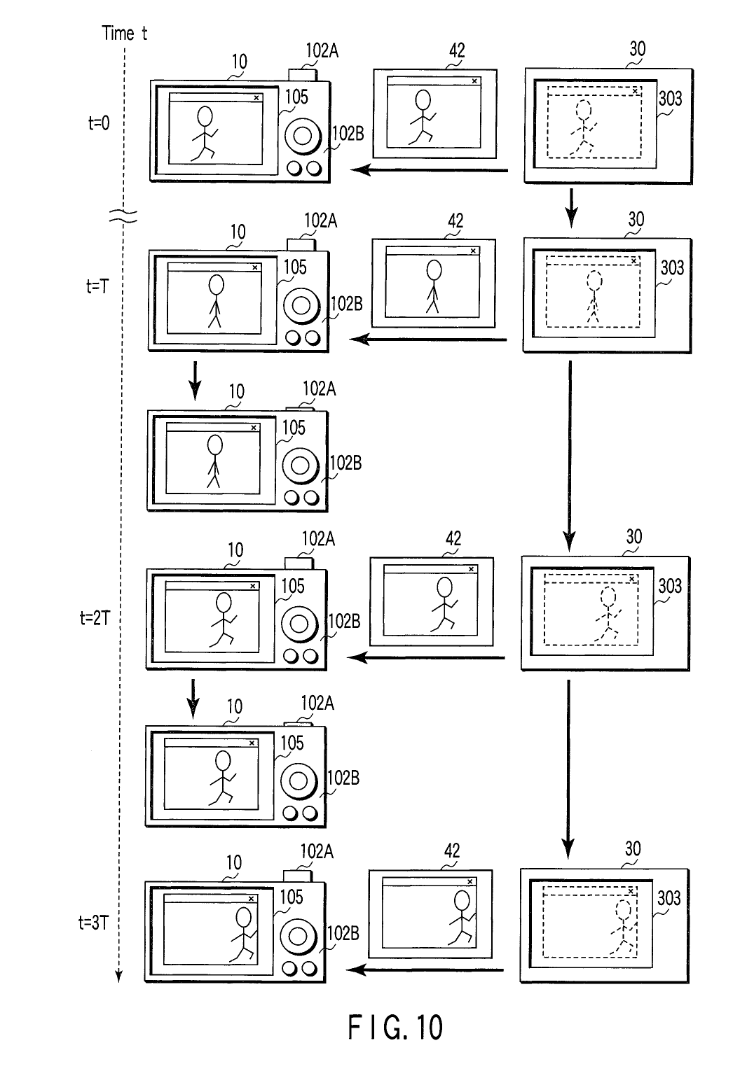

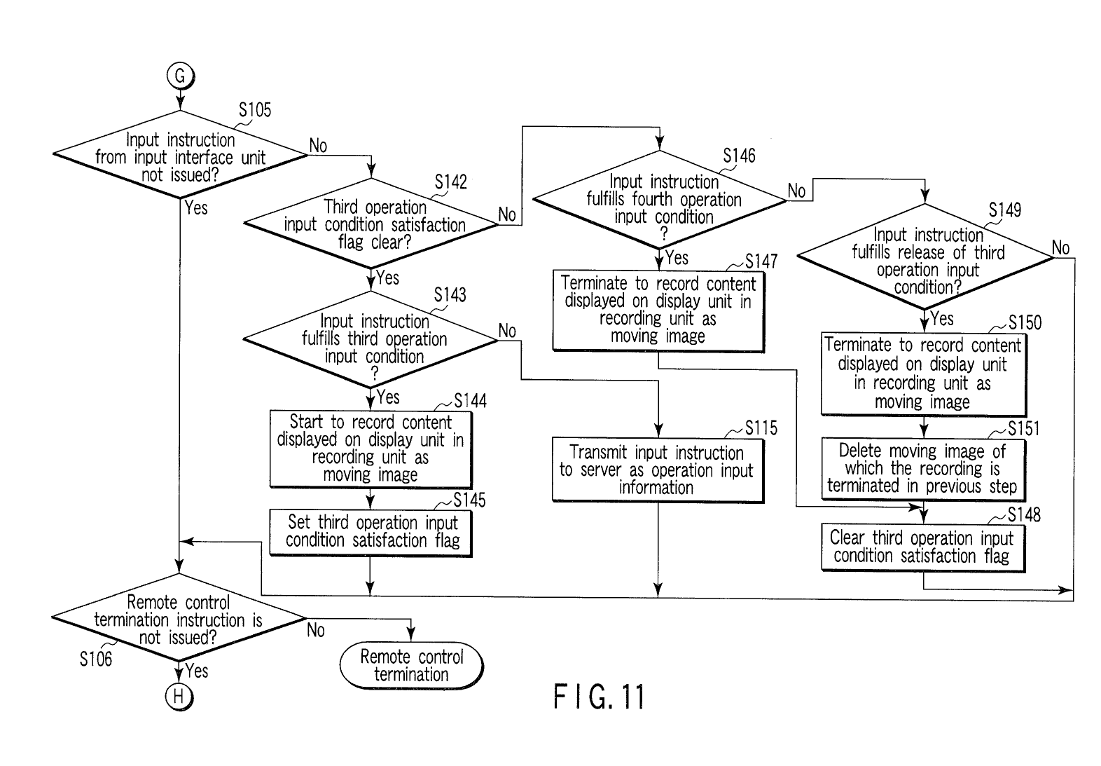

In the same manner as that of the first embodiment, in the third embodiment, for example, as shown in FIG. 10, the server 30 internally reproduces the moving images and updates the screen through the internal processing. The processing result information 42 is transmitted to the DSC 10 for each predetermined time interval. The DSC 10 displays the processing result information 42 to be received for each predetermined time interval on the display unit 105 as content. That is, the content received at the point of time of t=0 is displayed up to the point of time of t=T, new content is received at the point of time of t=T and the display is updated. In this way, the display will be updated for each predetermined time.

In Step S105, if it is determined that the input instruction from the input interface 102 has been performed, the CPU 101 determines whether or not the third operation input condition satisfaction flag is cleared (Step S142). Here, it is determined that the third operation input condition satisfaction flag is cleared, the CPU 101 further determines whether or not the input instruction satisfies the third operation input condition (Step S143). It is assumed that the third operation input condition is satisfied when the two-stage pushbutton switch 102A at the input interface unit 102 of the DSC 10 is fully pushed, and that a fourth operation input condition mentioned below is satisfied when the button switch 102A is fully pushed again. If it is determined that the input instruction does not satisfy the third operation input condition, the CPU 101 determines that the input instruction is performed by the key unit 102B such as the cross key, of the input interface unit 102. The DSC 10 transmits the input instruction to the server 30 from the external interface 106 via the network 20 as the operation input information 41 (Step S115) to proceed to Step S106.

Conversely, if it is determined that the input instruction satisfies the third operation input condition in Step S143, the file management unit 107 starts to record the content in display on the display unit 105 in the recording unit 108 as the moving images (Step S144). The management unit 107 sets the third input condition satisfaction flag (Step S145) to precede to Step S106. Thus, after setting the third operation input condition satisfaction flag, even when the DSC 10 proceeds to Steps S106, S104 and S107, the third embodiment may update the screen without fixing the display.

For instance, when the button switch 102A is fully pushed for the time period from the point of time of t=T to the point of time of t=2T and the third operation input condition is satisfied, the content displayed at that time, namely the content based on the processing result information 42 received at the point of time of t=T is recorded in the recording unit 108. At the point of time of the next time of t=2T, the screen updated through the internal processing in the server at that time is transmitted as the processing result information 42. When receiving the processing result information 42, the DSC 10 stores the processing result information 42 in the RAM 104, updates the display of the content, and also records the displayed content in the recording unit 108. In this way, the recording unit 108 continuously records the content based on the processing result information 42 transmitted from the server 30 for every predetermined time interval (T). That is, the content is recorded as the moving images.

When any input instruction is issued from the input interface unit 102, the DSC 10 proceeds from Step S105 to Step S142. Here, since the third input condition satisfaction flag is set in Step S145, the CPU 101, at this time, determines whether or not the input instruction fulfills the fourth operation input condition (Step S146). If it is determined that the input instruction does not fulfill the fourth operation input condition, the DSC 10 proceeds to Step S106. That is, during the recording of the imaging image, the operation by the key unit 102B such as the cross key, of the interface unit 102 are not accepted.

Conversely, when the button switch 102A of the DSC 10 is fully pushed, the CPU 101 determines that the input instruction fulfills the fourth operation input condition in Step S146. In this case, the CPU 101 terminates the recording of the content in display on the display unit 105 in the recording unit 108 as the moving images (Step S147). The CPU 101 then clears the third operation input condition satisfaction flag (Step S148), and the DSC 10 proceeds to Step S106.

For instance, if the button switch 102A is fully pushed again for the time period from the point of time of t=2T to the point of time of t=3T, the DSC 10 terminates the recording into the recording unit 108 until the point of time of t=2T. At the point of time of t=3T, the screen updated by the internal processing of the server 30 at that time is transmitted as the processing result information 42. When receiving the processing result information 42, the DSC 10 stores the received processing result information in the RAM 104, and updates the display of the content depending on the processing result information 42.

As given above, according to the third embodiment, the information processing system may record the processing result information 42 by the server 30 to be displayed on the DSC 10 as the moving images desired by the user. Thus, the user may easily confirm the processing result information 42 and may reuse the processing result information 42.

According to the third embodiment, each of the processing result information 42 to be received for the time period from the time when the third operation input condition is satisfied and up to the time when the fourth operation input condition is satisfied becomes each frame of the moving images to be stored in the recording unit 108, and frame rates become reception intervals of the processing result information 42. However, the frame rates of the moving images may differ from the reception intervals of the processing result information 42. For instance, so as not to enlarge file sizes of the moving images to be recorded in the recording unit 108, the moving images may be recorded at the frame rates lower than the reception intervals of the processing result information 42.

The third operation input condition may be satisfied when the button switch 102A is half-pushed, and the fourth operation input condition may be satisfied when the button switch 102A is fully pushed. In this case, the moving images are recorded for the time period from the time when the button switch 102A is half-pushed up to the time when the button switch 102A is fully pushed.

If such a third operation input condition is set to the case of the half-push of the button switch 102A, the fourth operation input condition may be set to the case in which the button switch 102A is not fully pushed and the half-push of the button switch 102A is released. To deal with such a case, if it is determined that the input instruction does not fulfill the fourth operation input condition in Step S146 as shown in FIG. 11, the CPU 101 further determines whether or not the input instruction fulfills the release of the third operation input condition (Step S149). If it is determined that the input instruction does not fulfill the release of the third operation input condition, the DSC 10 proceeds to Step S106. Conversely, if it is determined that the input instruction fulfills the release of the third operation input condition, the DSC 10 terminates the recording of the content in display on the display unit 105 in the recording unit 108 as the moving images (Step S150). The file management unit 107 deletes the moving images recorded in the recording unit 108 for the time period from the start in Step S144 to the end in Step S150 (Step S151). After this, the CPU 101 clears the third operation input condition satisfaction flag (Step S148), and the DSC 10 proceeds to Step S106.

As described above, in the case in which the button switch 102A is not fully pushed after the button switch 102A has been half-pushed and then the half-pushed state is released, the DSSC 10 terminates the recording of the moving images, determines the user does not intend to store the moving images and deletes the already recorded moving image.

Of course, it is possible for the DSC 10 to be configured so as to store the moving image without conducting the deletion operation in Step S151 and to be deleted the already recorded moving image through the operation of the key unit 102B such as the cross key, of the input interface unit 102 by the user if necessary.

While the present invention has described on the basis of the aforementioned embodiments, the invention is not limited to the embodiments, the invention may be embodied in various forms without departing from the spirit or scope of the general inventive concept thereof.

For instance, supplying a software program realizing the functions of the embodiments to a computer, and execution of the program by the computer enables realizing the functions given above.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An information processing system, comprising:
an information terminal; and
a server apparatus connected with the information terminal in a data communicable manner,
the server apparatus including a screen data generation unit configured to generate screen data of a screen to be displayed on an operation screen of the information terminal in response to one of data transmitted from the information terminal and internal processing of the server apparatus and to transmit the screen data to the information terminal, and
the information terminal including:
an operation input unit configured to perform an operation input regarding the information terminal;
an operation screen control unit configured to update display content on the operation screen of the information terminal on the basis of the screen data to be transmitted from the server apparatus; and
a storage unit configured to store the display content displayed on the operation screen in response to a first operation input.

2. The system according to claim 1, wherein:
when a second operation input is performed, the operation screen control unit holds the display content on the operation screen at that time; and
when the first operation input is performed, the storage unit stores the display content on the operation screen held in the operation screen control unit, and the operation screen control unit restarts to update the display content of the operation screen control unit.

3. The system according to claim 2, wherein
the operation screen control unit displays the display content on the operation screen held in the operation screen control unit at least one time period of (1) until the second operation input is released, (2) until the first operation input is performed, and (3) until a storage operation of the display content of the held operation screen after the second operation input has been terminated.

4. The system according to claim 1, further comprising:
a screen data transmission stop request unit which is disposed on the information terminal and makes a transmission stop request of the screen data to the server apparatus when the second operation input is performed, wherein
the screen data generation unit stops to transmit the screen data to the information terminal when a transmission stop request of the screen data is made.

5. The system according to claim 4, further comprising:
a screen data transmission restart request unit which is disposed on the information terminal and makes a transmission restart request of the screen data to the server apparatus at least one of when the first operation input is performed and when the second operation input is released.

6. The system according to claim 2, wherein
the operation input unit includes a two-stage pushbutton switch, and
the pushbutton switch is configured to perform the second operation input by a first-stage pushbutton operation and the first operation input by a second-stage pushbutton operation.

7. The system according to claim 1, wherein
the screen data includes one of content in which an image of a screen to be displayed on the operation screen of the information terminal is converted and a drawing command to display the content on the operation screen of the information terminal.

8. An information processing system, comprising:
an information terminal; and
a server apparatus connected with the information terminal in a data communicable manner,
the server apparatus including a screen data generation unit configured to generate screen data of a screen to be displayed on an operation screen of the information terminal in response to one of data transmitted from the information terminal and internal processing of the server apparatus and to transmit the screen data to the information terminal, and
the information terminal including:
an operation input unit configured to perform an operation input regarding the information terminal;
an operation screen control unit configured to update display content on the operation screen of the information terminal on the basis of the screen data to be transmitted from the server apparatus; and
a storage unit configured to start to store the display content displayed on the operation screen in response to a third operation input, and to terminate to store the display content displayed on the operation screen in response to a fourth operation input.

9. An information terminal which is data communicable with an external server apparatus, comprising:
an operation screen control unit configured to update display content of an operation screen on the basis of screen data to be transmitted from the server apparatus;
an operation input unit configured to perform an operation input regarding the information terminal; and
a storage unit configured to store the display content displayed on the operation screen in response to a first operation input.

10. The terminal according to claim 9, wherein:
when a second operation input is performed, the operation screen control unit holds the display content on the operation screen at that time, and
when the first operation input is performed, the storage unit stores the display content on the operation screen held by the operation screen control unit, and the operation screen control unit restarts to update the display content on the operation screen.

11. The terminal according to claim 10, further comprising:
a screen data transmission stop request unit configured to make a transmission stop request of the screen data to the server apparatus when the second operation input is performed.

12. The terminal according to claim 11, further comprising:
a screen data transmission restart request unit configured to make a transmission restart request of the screen data to the server apparatus at least one of when the first operation input is performed and when the second operation input is released.

13. A server device connected with an external information terminal in a data communicable manner, comprising:
a screen data generation unit configured to generate screen data of a screen to be displayed on an operation screen of the external information terminal in response to one of data transmitted from the external information terminal and processing in the server apparatus and to transmit the screen data to the external information terminal; and
a screen data transmission control unit configured to stop to transmit the screen data to the external information terminal when a transmission stop request of the screen data is made from the external information terminal, and to restart to transmit the screen data to the external information terminal when a transmission restart request of the screen data is made from the external information terminal.
